(19) United States
(12) Patent Application Publication
(10) Pub. No.: US 2004/0205120 A1
(43) Pub. Date: Oct. 14, 2004

(54) Network service optimization

(76) Inventors: Shaul Dar, Tel Aviv (IL); Boaz Kantor, Ramat Hasharon, IL (US); Eden Shochat, Ra'ananna (IL)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/395,742

(22) Filed: Mar. 24, 2003

(51) Int. Cl. G06F 15/16; G06F 15/173; G06F 3/00; G06F 13/00

(52) U.S. Cl. 709/203; 718/105; 719/311

(57) ABSTRACT

A system is for use with a data communication network that includes a plurality of servers and a plurality of programs to be run by the servers to provide a plurality of services to devices communicating with the servers over the network. The system comprises a memory that contains computer-readable and computer-executable instructions, and a processor coupled to the memory and configured to read and execute the instructions, the instructions being configured to cause the processor to determine a suggested mapping of the programs to the servers that is different than a current mapping of the programs to the servers.

### BACKGROUND OF THE INVENTION

Network servers provide a wide array of services to clients connected to the servers via a network. The servers run programs to provide services such as web content, FTP, email, e-commerce, printing, graphics, audio and/or video services, etc. Client requests are relayed via the network to the server that contains the program to provide the service needed by the request. Different servers typically store different sets of programs to provide different sets of services. The servers typically use varying amounts of resources over time (e.g., a day and/or week and/or month, etc.) to run the programs. The amount of resources used over time depends on several factors, e.g., the popularity of the services provided, the resource consumption of the services, and which services are provided by each server. Some programs may be used more often during the day (e.g., an email service) while others are used more often at night (e.g., a car buying website that may be used by working people from their home computers). How much resources are used and when they are used depends on the particular services provided by the servers.

Referring to FIG. 1, a typical client-network-server configuration 500 includes clients 502, a network 504, and several servers 506. The servers 506 include software programs that use stored data for providing services. If the servers 506 are database servers, the configuration 500 will also include database storage for the servers 506. This storage may be local storage for each of the servers 506, or may be a shared storage. With local storage, if a program is moved from one server to another, then the data corresponding to the program will need to be moved. With shared storage, moving a program between servers will not necessarily require movement of data corresponding to the moved program. The clients 502 may be applications servers, end user workstations, etc., and may access the servers 506 via the network 504 that is typically a packet-switched network, e.g., the Internet.

Improving performance of networks and network components is always desirable, and many efforts have been made in this regard. U.S. Pat. No. 6,505,249 (the '249 patent) discusses a method for optimizing end-to-end processing performance by selecting optimal values after running benchmarks repeatedly with different values. The '249 patent discusses a technique where variables that affect performance are identified, and baseline values for the variables are determined by testing. All the variables but one are set to their baseline values, while the remaining variable's value is varied and system performance is recorded for each value. This is repeated for each variable, and a system designer can use the recorded results to optimize hardware and software configurations. U.S. Pat. No. 6,059,842 (the '842 patent) discusses a system and method for optimizing computer software and hardware. The '842 patent discusses enhancing program application performance on a computer system. According to the '842 patent, configuration information and performance capabilities based on characteristics of the program/system are determined. Then, the configuration information and the performance capabilities are used to optimize configuration parameters of the program applications so as to enhance the performance of the workstation in running the program/system. U.S. Patent Application No. US 2002/0178075 A1 (the '075 application) discusses a method and apparatus for upgrade assistance using critical historical product information. The '075 application discusses embodiments for providing an integrated methodology that simplifies upgrade choices for complex computer products using automation and integration of product monitoring and business applications. Historical information for computer systems is collected and transmitted to a remote support system. According to the '075 application, over time, sufficient historical data provides a historical view of the systems indicative of usage that facilitates the choice of product enhancements, upgrades and customization.

### SUMMARY OF THE INVENTION

In general, in an aspect, the invention provides a system for use with a data communication network that includes a plurality of servers and a plurality of programs to be run by the servers to provide a plurality of services to devices communicating with the servers over the network. The system comprises a memory that contains computer-readable and computer-executable instructions, and a processor coupled to the memory and configured to read and execute the instructions, the instructions being configured to cause the processor to determine a suggested mapping of the programs to the servers that is different than a current mapping of the programs to the servers.

Implementations of the invention may include one or more of the following features. The instructions are configured to cause the processor to determine the suggested mapping such that the suggested mapping would have yielded better server resource utilization over a past time period than the current mapping. The instructions are configured to cause the processor to determine the suggested mapping such that the suggested mapping would have yielded better load balancing over the past time period than the current mapping. The instructions are configured to cause the processor to determine the suggested mapping such that the suggested mapping would have yielded better cumulative server resource utilization for all of the servers combined over the past time period than the current mapping. The instructions are configured to cause the processor to analyze a performance characteristic of the servers to determine the suggested mapping. The instructions are configured to cause the processor to measure the performance characteristic. The instructions are configured to cause the processor to measure the performance characteristic of the servers over time with the programs associated with the servers according to the current mapping and to determine the suggested mapping using values of the performance characteristic measured over time.

Implementations of the invention may also include one or more of the following features. The instructions are configured to cause the processor to analyze a performance characteristic of the servers associated with the current mapping and to determine an expected performance characteristic of the suggested mapping based on the analyzed performance characteristic of the current mapping. The analyzed performance characteristic and the expected performance characteristic are related to server load. The analyzed performance characteristic and the expected performance characteristic are server load variance. The instructions are configured to cause the processor to analyze a performance characteristic of the servers associated with a plurality of potential mappings and wherein the suggested mapping provides a minimum load variance of the plurality of potential mappings. The instructions are configured to cause the processor to analyze a performance characteristic of the servers associated with a plurality of potential mappings and wherein the instructions are configured to cause the processor to determine the at least one expected performance characteristic only for potential mappings that meet a constraint. The constraint is at least one of a required association of a selected server and a selected program, and a maximum number of programs that can be associated with a selected server. The instructions are configured to cause the processor to determine the expected performance characteristic using precalculated impacts of moves of programs between servers.

Implementations of the invention may also include one or more of the following features. The instructions are configured to cause the processor to analyze a performance characteristic of the servers associated with a plurality of mappings of the programs to the servers and to provide an indication of the suggested mapping, the suggested mapping being one of the plurality of mappings whose analyzed performance characteristic better meets a criterion than another of the plurality of mappings. The instructions are configured such that the suggested mapping meets at least one predetermined criterion. The at least one predetermined criterion is at least one of (1) that a load for a selected server is less than a threshold load, (2) that a selected program is associated with a selected server, and (3) that a selected server has less than a threshold number of programs associated with the selected server.

In general, in another aspect, the invention provides a method of operating a data processor in a network including clients and service programs associated with servers. The method comprises conveying data from the clients toward the servers, conveying data from the servers toward the clients, and determining a second mapping of the programs to the servers that is different than a first mapping of the programs to the servers that is currently used.

Implementations of the invention may include one or more of the following features. The determining determines the second mapping such that the second mapping would have yielded better server resource utilization over a past time period than the first mapping. The determining determines the second mapping such that the second mapping would have yielded better load balancing over the past time period than the first mapping. The determining determines the second mapping such that the second mapping would have yielded better cumulative server resource utilization for the servers over the past time period than the first mapping. The method further comprises analyzing a performance characteristic of the servers to determine the second mapping. The method further comprises measuring the performance characteristic. The measuring measures the performance characteristic of the servers over time with the programs associated with the servers according to the first mapping and the determining determines the second mapping using values of the performance characteristic measured over time.

Implementations of the invention may also include one or more of the following features. The method further comprises analyzing a performance characteristic of the servers with the programs associated with the servers according to the first mapping and the determining determines an expected performance characteristic for the second mapping based on the analyzed performance characteristic of the first mapping. The analyzed performance characteristic and the expected performance characteristic are related to server load. The analyzed performance characteristic and the expected performance characteristic are server load variance. The analyzing analyzes a performance characteristic of the servers associated with each of a plurality of potential mappings and wherein the second mapping provides a minimum load variance of the plurality of potential mappings. The analyzing analyzes a performance characteristic of the servers associated with a plurality of potential mappings and wherein the determining determines the at least one expected performance characteristic only for potential mappings that meet a constraint. The constraint is at least one of a required association of a selected server and a selected program, and a maximum number of programs that can be associated with a selected server. The determining determines the expected performance characteristic using precalculated impacts of moves of programs between servers.

Implementations of the invention may also include one or more of the following features. The method further comprises analyzing a performance characteristic of the servers associated with a plurality of mappings of the programs to the servers and to provide an indication of the second mapping, the second mapping being one of the plurality of mappings whose analyzed performance characteristic better meets a criterion than another of the plurality of mappings. The second mapping meets at least one predetermined criterion. The at least one predetermined criterion is at least one of (1) that a load for a selected server is less than a threshold load, (2) that a selected program is associated with a selected server, and (3) that a selected server has less than a threshold number of programs associated with the selected server.

In general, in another aspect, the invention provides a computer program product for use in a system configured to be used with a data communication network that includes a plurality of servers and a plurality of programs to be run by the servers to provide a plurality of services to devices communicating with the servers over the network, the computer program product residing on a computer-readable medium and comprising computer-readable and computer-executable instructions for causing a computer to determine a suggested mapping of the programs to the servers that is different than a current mapping of the programs to the servers.

Implementations of the invention may include one or more of the following features. The instructions are configured to cause the computer to determine the suggested mapping such that the suggested mapping would have yielded better server resource utilization over a past time period than the current mapping. The instructions are configured to cause the computer to determine the suggested mapping such that the suggested mapping would have yielded better load balancing over the past time period than the current mapping. The instructions are configured to cause the computer to determine the suggested mapping such that the suggested mapping would have yielded better cumulative server resource utilization for the servers over the past time period than the current mapping. The instructions are configured to cause the computer to analyze a performance characteristic of the servers to determine the suggested mapping. The instructions are configured to cause the computer to measure the performance characteristic. The instructions are configured to cause the computer to measure the performance characteristic of the servers over time with the programs associated with the servers according to the current mapping and to determine the suggested mapping using values of the performance characteristic measured over time.

Implementations of the invention may also include one or more of the following features. The instructions are configured to cause the computer to analyze a performance characteristic of the servers associated with the current mapping and to determine an expected performance characteristic of the suggested mapping based on the analyzed performance characteristic of the current mapping. The analyzed performance characteristic and the expected performance characteristic are related to server load. The analyzed performance characteristic and the expected performance characteristic are server load variance. The instructions are configured to cause the computer to analyze a performance characteristic of the servers associated with a plurality of potential mappings and wherein the suggested mapping provides a minimum load variance of the plurality of potential mappings. The instructions are configured to cause the computer to analyze a performance characteristic of the servers associated with a plurality of potential mappings and wherein the instructions are configured to cause the computer to determine the at least one expected performance characteristic only for potential mappings that meet a constraint. The constraint is at least one of a required association of a selected server and a selected program, and a maximum number of programs that can be associated with a selected server. The instructions are configured to cause the computer to determine the expected performance characteristic using precalculated impacts of moves of programs between servers.

Implementations of the invention may also include one or more of the following features. The instructions are configured to cause the computer to analyze a performance characteristic of the servers associated with a plurality of mappings of the programs to the servers and to provide an indication of the suggested mapping, the suggested mapping being one of the plurality of mappings whose analyzed performance characteristic better meets a criterion than another of the plurality of mappings. The instructions are configured such that the suggested mapping meets at least one predetermined criterion. The at least one predetermined criterion is at least one of (1) that a load for a selected server is less than a threshold load, (2) that a selected program is associated with a selected server, and (3) that a selected server has less than a threshold number of programs associated with the selected server.

Various aspects of the invention may provide one or more of the following advantages. Programs for providing services by servers can be allocated to the servers to improve resource utilization by the servers. Programs can be allocated to servers while following constraints such as requirements for particular servers to provide particular services. Network server load balancing may be improved. Availability and/or scalability of network servers can be improved.

These and other advantages of the invention, along with the invention itself, will be more fully understood after a review of the following figures, detailed description, and claims.

### BRIEF DESCRIPTION OF THE FIGURES

FIG. 1 is a simplified diagram of a typical database network implementation.

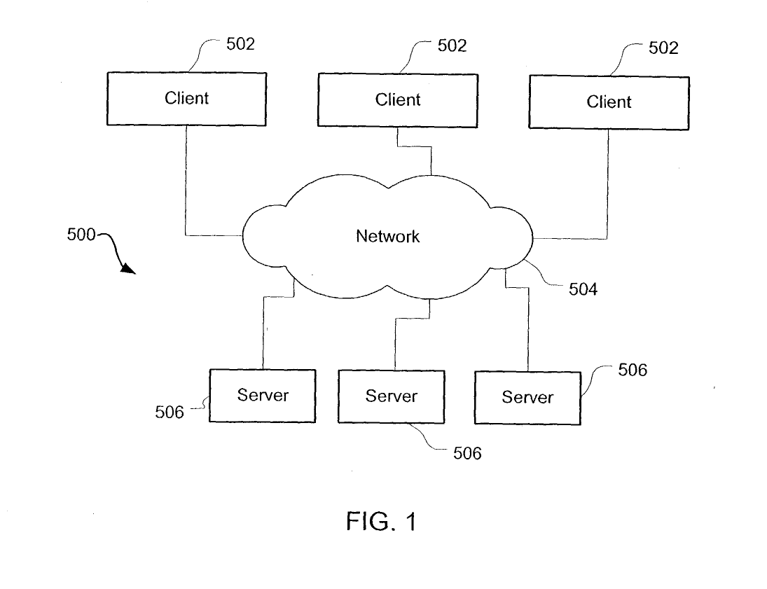

FIG. 2 is a simplified diagram of a network including a switch that can evaluate different mappings of programs to servers included in the network.

FIGS. 3A-3B are simplified block diagrams of components of the switch shown in FIG. 2.

FIG. 4 is a graph showing server processor load variance before and after rearrangement of program-to-server mapping by the switch shown in FIG. 2.

FIG. 5 is a graph indicating a relationship between quality of program-to-server mapping versus program relocation cost.

FIG. 6 is a block flow diagram of a process of determining suitable reassignment of programs to servers.

### DETAILED DESCRIPTION OF PREFERRED EMBODIMENTS

Some embodiments of the invention provide techniques for assigning programs to network servers to improve use of the servers' resources. Programs to be run by various servers can be assigned to the servers such that the servers' resources, e.g., central processing unit (CPU) load, input/output (I/O) load, and memory used, can be better used than without the assignment provided by the invention. A system according to some embodiments of the invention can analyze one or more server metrics over time with the programs assigned to the servers in one combination to determine the programs' effects upon the metric(s). Using these historical effects, the system can determine historical impact of each program upon the metric(s). The system can use the determined impacts to analyze different mappings of the programs to the servers to determine which combination(s) of programs and servers would have provided improved/desirable server metric(s), e.g., resource usage. A mapping that would have yielded better results can be implemented for future use under the assumption that the past will be similar to future server usage. Other embodiments are within the scope of the invention.

As an example, the following description discusses database services and a database managing switch. The invention, however, is not limited to database servers, database managing switches, or database services as other types of servers, managing switches, and/or services are acceptable and within the scope of the invention. For example, the servers could be configured to provide any of a wide range of services such as web content, FTP, email, e-commerce, printing, graphics, audio and/or video services, etc.

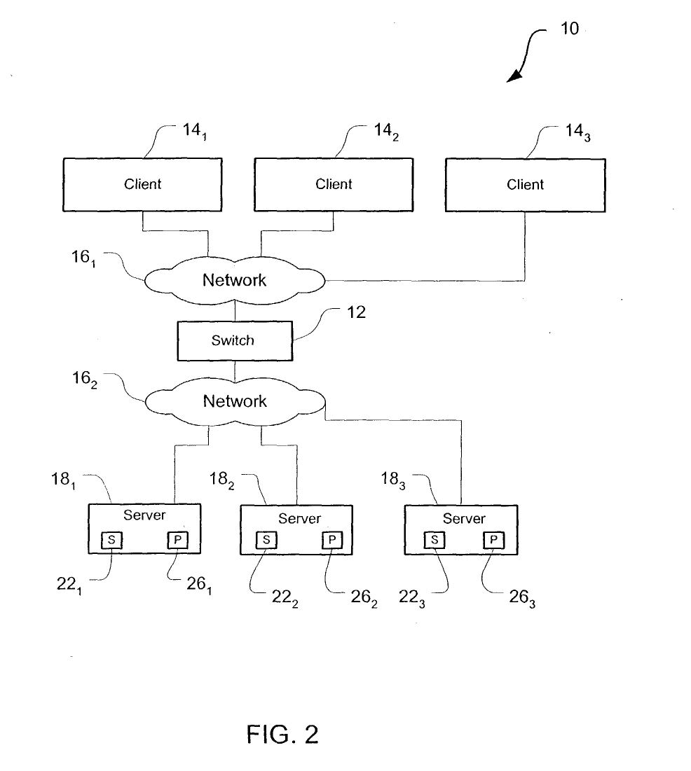

Referring to FIG. 2, a communication system 10 includes a switch 12, three clients 14, a network 16, and three servers 181-183. While three clients 14 and three servers 18 are shown, the system 10 is scalable such that other quantities of the clients 14 and/or the servers 18 are possible and would be acceptable. Separate storages may be provided for some or all of the servers 18 instead of the shared storage 20, or the storage 20 may be eliminated from the system 10, e.g., if the servers 18 are not database servers. If the servers 18 are database servers, then the switch 12 is a database switch (dbSwitch) and the system 10 will include storage for data for programs implemented by the servers 18. If the storage is shared by the server 18, then moving programs among the servers 18 can be done without moving the data associated with the moved programs, while moving data may be needed if local storage is provided for each of the servers 18. The system 10 is configured for packetized data communications, e.g., with the network 16 being a packet-switched communication network such as a local area network (LAN), a wide area network (WAN), or the global packet-switched network known as the Internet.

The servers 18 include software 22 that includes Database Management System (DBMS) software including database programs (called database instances for Oracle® servers) that are assigned to the various servers 18. The servers 181-183 include processors, e.g., CPUs, 261-263 that are configured to perform tasks according to the computer-readable and computer-executable software 22.

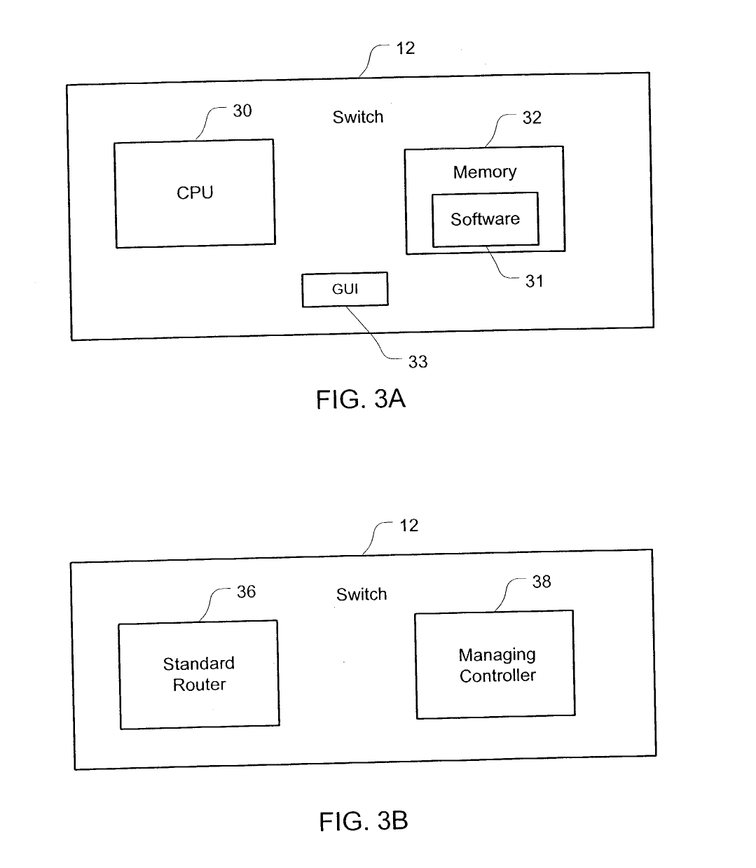

Referring also to FIG. 3B, the switch 12 includes a router 36 and a managing controller 38. As shown and preferred, the router 36 and the controller 38 are implemented as separate physical devices, but may be implemented as a single device. The following description refers to the router 36 and/or the controller 38 as the switch 12. The router 36 can perform typical router functions including network address translation (NAT) from virtual addresses to actual addresses and vice versa, routing of packets, and using access control lists (ACLs). The managing controller 38 is configured to control the router 36 to perform functions described below.

Referring to FIGS. 2 and 3A, the switch 12 includes a processor 30 for executing a computer-readable and computer-executable software program 31 stored in a memory 32 in the switch 12. The switch 12, by having the processor 30 execute the software code 31, can perform operations as discussed below. The switch 12 is coupled and configured to receive indicia regarding the health of the servers 18. For example, the switch 12 can monitor the operation and/or performance of the servers 18 including, e.g., available capacity and resources used by the programs. The switch 12 can monitor the health of the servers 18 by monitoring and aggregating metrics indicative of the health. Such metrics include processor (CPU) memory, and input/output (I/O) metrics. This monitoring may be periodic, e.g., every 10 seconds, although an asynchronous monitoring, or a synchronous monitoring of a different period would be acceptable.

The switch 12 is configured to analyze the monitored data from the servers 18, e.g., the processors 26. The switch 12 can thus determine the server processor (CPU) load for each of the servers 18 over time, and the contributions to the load by each of the programs on each particular server 18. The switch 12 can also determine the contribution to the overall load on the servers 18 by blocks of multiple programs (a program, referring to a server program, as used herein refers to either an individual program or a block of programs). Further, the switch 12 can determine a cumulative load for all the server processors 26, here the three processors 26₁-26₃. Given this load, the processor 30 can determine the average load for the processors 26, and thus what the load on each processor 26 would be if the load was uniformly distributed (perfectly balanced). Knowing the per-server load-balanced load, the switch 12 can determine a load variance indicative of the cumulative magnitude difference between individual actual loads on the servers 18 and the uniformly-distributed load. Variance at each time t may be determined by the switch 12 according to:

$${V}_{t} = {\sum }_{u = 0}^{N - 1} {( \frac{1}{N} {\sum }_{i = 0}^{{M}_{u} - 1} Load ( {I}_{i}^{u} , t ) )}^{2} - {( \frac{1}{N} {\sum }_{u = 0}^{N - 1} {\sum }_{i = 0}^{{M}_{u} - 1} Load ( {I}_{i}^{u} , t ) )}^{2} ; variance of server loads in time t .$$

where N is the number of the servers 18, M is the number of programs for the servers 18, Mᵤ is the number of programs on the u-th server 18, I^{u}_{I} is the i=th program of the u-th server 18, and Load(I^{u}ᵢ,t) is the CPU load of the u-th server 18 due to the i-th program at time t. The variance Vᵢ can be accumulated for all times t according to:

$$V = {\sum }_{t} {V}_{t}$$

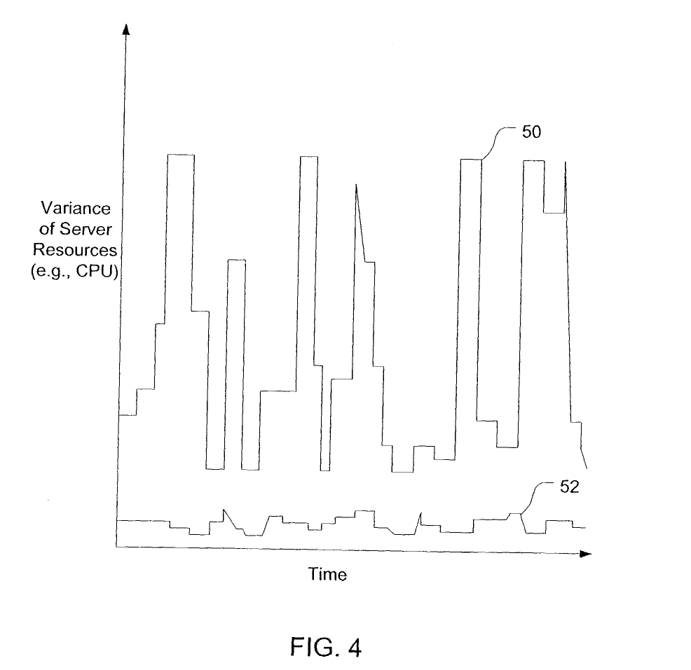

Referring also to FIG. 4, the load variance 50 with an initial assignment of programs to the servers 22 is determined by the switch over time. FIG. 4 represents data obtained by the switch over a period of time using a system similar to that shown in FIG. 2. The graph shown in FIG. 4 may be presented to a user of the switch 12, e.g., on a user interface 33, so that the user can see the undesirable utilization of server resources using the current mapping of programs to servers. For each point in time, the variance 50 shows the cumulative magnitude difference between actual loads on the servers 18 and a theoretical load for each server 18 if the total load for the servers 18 at each point in time was perfectly uniformly distributed among all the servers 18. The switch 12 can be configured to analyze the server processor load over various time intervals, or to have a time interval selected/entered by a user, e.g. of the user interface 33 of the switch 12. The user interface 33, e.g., a graphical user interface (GUI), is configured to allow visual/audio (including text) interaction between a user and the switch 12.

The switch 12 is configured, according to the program 31, to determine a desirable mapping/association of programs and servers 22. The switch 12 treats the possible mappings of programs to servers (each mapping being a set of assignments of programs to servers) as a search “space” and searches through these possibilities for a solution (mapping) that satisfies one or more measures of quality. In a preferred embodiment, the switch 12 is configured to find a solution that optimizes the historical variance over time of free server resources in the servers 18. The optimization provided by the switch 12 is constrained by the available possible mappings, and thus may not be a theoretical optimization of server resources. Optimization refers to running of a computer system more efficiently, for example, by improving the speed at which a software application runs, and/or improving user satisfaction, and/or reducing cost and/or resource use. The variance is preferably minimized over all of the servers 18 given the possible mappings. In other words, the switch 12 preferably, although not necessarily, seeks to load balance the servers 22 over time as best as possible with the available mappings. To do this, the switch 12 is configured to determine the variance of the server processor loads for various solutions based on the historical data of processor load impact of each of the programs. It is assumed that the future load impact of a database will be the same as or similar to its historical impact, and thus that optimizing historical load variance will likely provide an optimized future load variance. The historical loads may be stored in a variety of ways, such as hourly averages of measurements. The historical load values are preferably not determined during runtime of the program 31.

The processor 30 may analyze the possible solutions, or subsets of the possible solutions, in a variety of ways. For example, the processor 30 may try each solution, and analyze the variance, or may use precalculated impacts of various transitions, e.g., moving program X from the server 222 to the server 223 to determine the overall variance of a proposed solution. The processor 30 may maintain the precalculated impacts for future analysis and may update the various pre-calculations based on further measurements, e.g., as they are received.

In order to compare servers with disparate characteristics, the switch 12 is configured to apply metrics to normalize resource measurements (e.g., server processor load). For example, the switch 12 may be configured to use the square root of a server processor's clock frequency as a normalizer. Thus, if the server processor 26₁ operates at 800 MHz and the server processor 26₂ operates at 400 MHz, then the metric for the processor 26₁ will be 1.44 times the metric for the processor 26₂.

The switch 12 may also analyze the Quality of Service (QoS) of various solutions. For example, the switch 12 can analyze performance criteria affecting QoS such as response time, throughput (packets/second or transactions/second), etc. The switch 12 can try to find a solution that optimizes one or more of these performance criteria. The criteria may or may not be weighted during the optimization process.

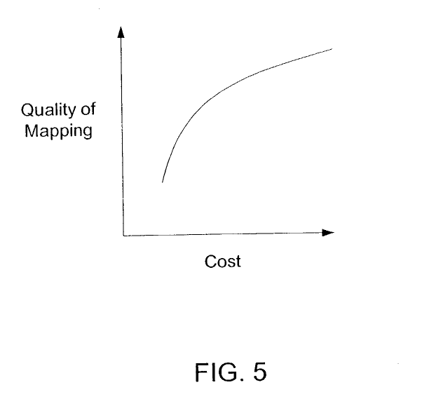

The processor 30 may also consider the relocation cost of moving programs according to possible solutions versus the current assignments of the programs. Referring also to FIG. 5, often there can be a significant increase in the quality of mapping (e.g., significantly more desirable characteristics such as load variance) with a few relocations of programs versus a current setup. Further, increasing the number of relocations often results in a diminishing return of relocation cost versus performance impact. Thus, the processor 30 may also use the cost of relocating more programs, e.g., the cost due to downtime of the program while it is moved, to affect the proposed “best” solution. Further, the processor 30 may present a user, e.g., of the user interface 33, with a list of possible solutions and their corresponding impacts on performance including the number of program relocations. The switch 12 may prompt the user to select which solution the user wishes.

The switch 12 is preferably also configured to, though not required to be configured to, allow the user to specify characteristics, e.g., of a server 18, and/or desired mappings. For example, the user may designate the maker (e.g., Sun Microsystems of Menlo Park, Calif.), the storage capacity (e.g., 4 GB), and/or other operationally-significant parameters of any of the servers 18. The switch 12 is also preferably configured to allow the user to specify assignments of particular programs to particular servers 18. The switch 12 is configured to determine one or more recommended solutions based on the user-specified constraints, if any. The user may also designate the time interval over which the switch 12 should evaluate the servers 18 in determining server variance.

The switch 12 may include, or allow a user to include, a threshold for any of the servers 18. This threshold can specify the maximum amount of server capacity (which may include processor, I/O, memory, etc.) to be reserved. Thus, the user or the program may designate T% of any of the servers 18 as a reserve capacity amount with the remainder of the capacity (100-T)% being available for the assigned programs. This can, for example, model other programs (that are not part of the evaluation and assignment) running on the processors 26. The reserve capacity amount T may be different for each of the servers 18.

The switch 12 can reduce the number of possible mappings to consider. Thus, the switch 12 can trim the search space from all possible program mappings to a subset and explore the subset of mappings. The switch 12 can use a local optima method such as simulated annealing to determine the subset. Further, metrics other than processor speed, such as memory, can be used as a filter to avoid some solutions (i.e., eliminate them from consideration). Exemplary assignments to be avoided can include assignments of programs to servers 18 that could not store the assigned program, or that could store the assigned program, but would have performance unacceptably degraded due to the assignment. The switch 12 could also apply limitations to eliminate solutions from consideration. For example, the switch 12 could limit the number of programs that any one server 18 could have assigned to it to an upper limit L. This limit L can, for example, be twice the average number of programs per server (i.e., L=2(M/N) where M=the number of programs and N=the number of the servers 18).

The switch 12 can evaluate the solutions based upon both constraints and goals (e.g., desired, but not required, criteria). The switch 12 preferably discards any solution that does not meet a required constraint such as the maximum number of relocations. The switch 12 preferably finds solutions that meet goals, but can provide solutions that do not meet one or more goals, such as a desired maximum number of relocations. The switch 12 can further rank possible solutions according to whether they meet desired conditions (e.g., the variance is within a desired, acceptable maximum variance). Further, the switch 12 can rank solutions in accordance with weights of constraints/goals, e.g., such that a solution that provides a slight variance, but numerous relocations, may be ranked higher than a solution that provides few relocations, but a high variance, if the variance constraint is weighted heavier than number of relocations. The weights for constraints/goals may be pre-programmed and/or selected/modified by the user.

The switch 12 can determine and evaluate solutions using a standard traversal technique such as DFS (depth first search) combined with branch elimination to reduce the number of solutions evaluated. For example, the switch 12 can perform the following algorithm:

For this algorithm, a “state” is considered any number of programs assigned to the servers 18. When the number of assigned programs equals N, it is a full state. The algorithm builds a full state at a server 18 and then removes programs from the server 18 to try to assign the programs to the next free server 18. The full state may be fewer than all N programs if the server 18 cannot store all N programs or the maximum allowable number of programs is less than N.

Algorithm:

1. If there are no more programs to assign to servers, then there is a full state. Give it a score.

a. If score <lowestScoreSoFar, then

i. lowestScoreSoFar=score, bestState=found state,

b. Remove last-assigned program from state, and

c. Go back to 1.

2. If there is a program to assign but it is assigned to the last possible server, then

a. Remove the program from the state, and

b. Go back to 1.

3. If there is a program to assign and a server it was not assigned to, then

a. Check if adding this program to the new server does not exceed a maximum number of instances allowed, and overall memory consumption,

i. If so, then assign the program to the new server, and

b. Go back to 1.

Portion 3.a. of the algorithm provides for branch elimination in that branches in which the listed criteria are not met are not checked further. Brach elimination may not be employed, in which case 3.a.i. above would replace 3.a. above.

The switch 12 can determine a relocation cost associated with a new solution depending upon the number and type of programs to be relocated relative to the current mapping. FIG. 5 illustrates an example of a tradeoff that is typical between quality of mapping and relocation cost. To help the switch 12 determine relocation cost, the user can specify a rank for each program. This rank may be a cost factor, or may be related to a cost factor, e.g., a factor of 1.1 for no specific rank, 1.2 for a low rank, 1.3 for a medium rank, and 1.4 for a high rank. The factors indicate a relative willingness of the user to relocate the various programs. An overall relocation cost for a solution can be determined by multiplying the relocation factors for each relocated program. Thus, if one high-rank program, two medium-rank programs, and one low-rank program are to be relocated for a given solution, then the relocation cost for that solution is 1.4·1.3²1.2=2.84.

Also, the switch 12 is configured to estimate in advance of running of the software 31 what the runtime will likely be for determining one or more solutions. The switch 12 can inform the user through the interface 33 of the estimated runtime and the user can decide whether to run the program 31 and/or to set/modify parameters, e.g., to get faster results with a possible tradeoff in optimization of the program assignment solution. The run time is essentially the time to calculate a score for a solution times the number of full states evaluated. The number of full states evaluated is limited (ignoring memory branch elimination) to the number of ways of dividing M programs on N servers given that no more than MAX programs can be assigned to a single server 18. This number of ways is the coefficient of x^{M} in the expression

$$number of possibilities = coefficient of {x}^{M} of \text{:} {( {\sum }_{i = 0}^{MAX} {x}^{i} )}^{N}$$

The score calculation run time is linear in t, N, and M, yielding an overall run time of O(t·n·m·number of possibilities(N,M)).

Run time can be reduced by making score calculations reduce to evaluation of a constant, i.e., 0(c). Assuming the delta of a score from any given full state to another full state that differs from the full state by only one program, real score calculation can be done only once and new score calculations can be done according to the expression:

NewStateScore=OldStateScore+CalculateScoreDelta(OldState,NewState).

The impact of removing a member from a sample with value Val, where the sample has an overall value of OverAllVal, on the variance V, when the expectancy was Exp is: V=V+2·Val·(Exp−OverAllVal)−Val² (Note this formula as VarDelta(Val,overAllVal,Exp). Further, a three dimensional vector with dimensions: [N, 2^{M},M] can be determined that indicates the variance contribution of moving instance m [the last dimension] from server n [the first dimension] while a certain set of programs was assigned to the server [the middle dimension]. A CalcluateScoreDelta(n, conf, m) for removing instance m from server n when a configuration conf was assigned to server n would be the value at the proper indice in this array. These measures can be taken to build such an array:

Calculate the overall resources in the subdan

$$overallMetrics = {\sum }_{n} cpu\_metric ( {S}_{n} )$$

Hold a vector of expectancy (average) of loads on the servers for each time t:

$$load Exp [ t ] = \frac{1}{overallMetrics} {\sum }_{m} Load ( {I}_{m} , t )$$

Build a vector per server holding for every time ‘t’ the sum of loads of all possible configurations of instances

$$serverLoad [ server ] [ instance configuraion ] [ t ] = \frac{1}{cpu\_metric [ server ]} \cdot {\sum }_{min configuration} Load ( {I}_{m} , t )$$

Build the score delta vector:

$$ScoreDelta [ {S}_{n} , conf , {I}_{m} ] = {\sum }_{t} VarDelta ( Load ( {I}_{m} , t ) * cpu\_metric [ {S}_{n} ] , serverLoad [ {S}_{n} ] [ conf ] [ t ] , load Exp [ t ] ) ;$$

Thus, by using O(N·2^{M}·M) memory and O(t·N·M·2^{M}) precalculation time, score calculation run time reduces to a constant, 0(c).

The one or more solutions that preferably best satisfy the desired condition(s), e.g., reduction of load variance, desired QoS, and least or acceptable relocation cost, are provided by the switch 12 as the desired solution(s). Each suggested solution preferably meets any absolute criteria (e.g., maximum relocations) and multiple solutions are organized based upon desirability regarding weights of constraints and goals and whether they meet or do not meet the goals (e.g., maximum number of relocations). Referring again to FIG. 4, the switch 12 can determine, using the monitored historical data, and provide on the interface 33 a revised variance 52 indicative of what the server load over the monitored time would have been if a suggested solution had been implemented. Implementing the suggested solution will likely yield an actual variance similar to the revised variance 52.

The switch 12 is also configured to analyze a solution entered by the user. The user can enter, through the interface 33, a mapping of programs to servers 18. The switch 12 can analyze the entered mapping and provide indicia of the expected operational parameters, e.g., load variance, of such a mapping as well as the impact of implementing the mapping, e.g., relocation cost.

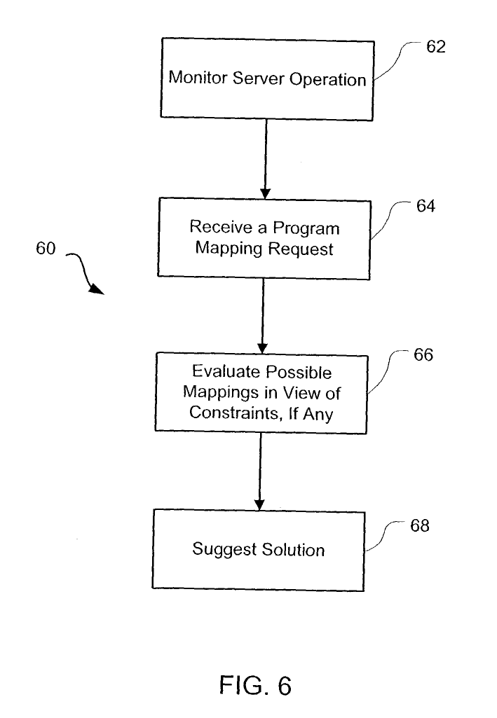

In operation, referring to FIG. 6, with further reference to FIGS. 2-5, a process 60 for determining and implementing a new mapping of databases to database servers using the system 10 includes the stages shown. The process 60, however, is exemplary only and not limiting. The process 60 can be altered, e.g., by having stages added, removed, or rearranged.

At stage 62, the switch 12 monitors operation of the servers 18. Under control of the program 31, the processor 30 measures desired metrics indicative of resource usage by the servers 18, e.g., the load of the processors 26, by monitoring and/or receiving metrics of/from the servers 18. The switch 12 determines averages, e.g., hourly, of the processor loads and also monitors the impact of each of the programs in the servers 18, e.g., upon the respective processors 26.

At stage 64, the switch 12 receives a request from the user through the interface 33 to determine a mapping of programs to the servers 18. The switch 12 also receives indicia from the user of any constraints, goals, and weights for determining possible solutions of programs and servers. For example, the constraints may include that certain programs be matched or not be matched with certain servers 18, what is the limit L of program-available processor load, what the maximum and/or desired maximum number of relocations is, what the maximum and/or desired maximum cost of relocation is, etc. The user may supply weight factors for constraints/goals for the switch 12 to use in evaluating which solution is better. These weights may modify pre-programmed weights.

At stage 66, the switch 12 evaluates possible solutions in accordance with performance characteristics constraints and goals of the solutions. The switch 12 can evaluate any solution requested by the user. The switch 12 also preferably searches the solution space (e.g., tries different mappings of programs and servers 18) and evaluates the expected performance of each mapping based upon the monitored historical data. The various solutions' performances are compared with constraints upon the performances that must be met and goals that are desired to be met. The switch 12 applies any appropriate weights to constraints and/or goals.

At stage 68, the switch 12 suggests one or more solutions. With the constraints and goals (if any) accounted for, the switch 12 provides one or more solutions associating programs to the servers 18 to the user through the user interface 33. The switch 12 preferably provides multiple solutions in order of desirability in accordance with whether and how well each solution meets any applicable performance characteristic constraints and/or goals, in view of associated weights. A selected one of the solutions can be implemented by reassigning the programs to the indicated servers 18. This involves moving the programs from the servers 18 that they are currently assigned to, to the servers 18 indicated by the selected solution, assuming the suggested server is different from the program's current server. Preferably, the reassignments are performed at a time that will least impact performance of the system 10, e.g., service to users of the services provided by the programs run by the servers 18.

Other embodiments are within the scope and spirit of the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A system for use with a data communication network that includes a plurality of servers and a plurality of programs to be run by the servers to provide a plurality of services to devices communicating with the servers over the network, the system comprising:
a memory that contains computer-readable and computer-executable instructions; and
a processor coupled to the memory and configured to read and execute the instructions, the instructions being configured to cause the processor to determine a suggested mapping of the programs to the servers that is different than a current mapping of the programs to the servers.

2. The system of claim 1 wherein the instructions are configured to cause the processor to determine the suggested mapping such that the suggested mapping would have yielded better server resource utilization over a past time period than the current mapping.

3. The system of claim 2 wherein the instructions are configured to cause the processor to determine the suggested mapping such that the suggested mapping would have yielded better load balancing over the past time period than the current mapping.

4. The system of claim 2 wherein the instructions are configured to cause the processor to determine the suggested mapping such that the suggested mapping would have yielded better cumulative server resource utilization for all of the servers combined over the past time period than the current mapping.

5. The system of claim 2 wherein the instructions are configured to cause the processor to analyze a performance characteristic of the servers to determine the suggested mapping.

6. The system of claim 5 wherein the instructions are configured to cause the processor to measure the performance characteristic.

7. The system of claim 6 wherein the instructions are configured to cause the processor to measure the performance characteristic of the servers over time with the programs associated with the servers according to the current mapping and to determine the suggested mapping using values of the performance characteristic measured over time.

8. The system of claim 1 wherein the instructions are configured to cause the processor to analyze a performance characteristic of the servers associated with the current mapping and to determine an expected performance characteristic of the suggested mapping based on the analyzed performance characteristic of the current mapping.

9. The system of claim 8 wherein the analyzed performance characteristic and the expected performance characteristic are related to server load.

10. The system of claim 8 wherein the analyzed performance characteristic and the expected performance characteristic are server load variance.

11. The system of claim 10 wherein the instructions are configured to cause the processor to analyze a performance characteristic of the servers associated with a plurality of potential mappings and wherein the suggested mapping provides a minimum load variance of the plurality of potential mappings.

12. The system of claim 8 wherein the instructions are configured to cause the processor to analyze a performance characteristic of the servers associated with a plurality of potential mappings and wherein the instructions are configured to cause the processor to determine the at least one expected performance characteristic only for potential mappings that meet a constraint.

13. The system of claim 12 wherein the constraint is at least one of a required association of a selected server and a selected program, and a maximum number of programs that can be associated with a selected server.

14. The system of claim 8 wherein the instructions are configured to cause the processor to determine the expected performance characteristic using precalculated impacts of moves of programs between servers.

15. The system of claim 1 wherein the instructions are configured to cause the processor to analyze a performance characteristic of the servers associated with a plurality of mappings of the programs to the servers and to provide an indication of the suggested mapping, the suggested mapping being one of the plurality of mappings whose analyzed performance characteristic better meets a criterion than another of the plurality of mappings.

16. The system of claim 1 wherein the instructions are configured such that the suggested mapping meets at least one predetermined criterion.

17. The system of claim 16 wherein the at least one predetermined criterion is at least one of (1) that a load for a selected server is less than a threshold load, (2) that a selected program is associated with a selected server, and (3) that a selected server has less than a threshold number of programs associated with the selected server.

18. A method of operating a data processor in a network including clients and service programs associated with servers, the method comprising:
conveying data from the clients toward the servers;
conveying data from the servers toward the clients; and
determining a second mapping of the programs to the servers that is different than a first mapping of the programs to the servers that is currently used.

19. The method of claim 18 wherein the determining determines the second mapping such that the second mapping would have yielded better server resource utilization over a past time period than the first mapping.

20. The method of claim 19 wherein the determining determines the second mapping such that the second mapping would have yielded better load balancing over the past time period than the first mapping.

21. The method of claim 19 wherein the determining determines the second mapping such that the second mapping would have yielded better cumulative server resource utilization for the servers over the past time period than the first mapping.

22. The method of claim 19 further comprising analyzing a performance characteristic of the servers to determine the second mapping.

23. The method of claim 22 further comprising measuring the performance characteristic.

24. The method of claim 23 wherein the measuring measures the performance characteristic of the servers over time with the programs associated with the servers according to the first mapping and the determining determines the second mapping using values of the performance characteristic measured over time.

25. The method of claim 18 further comprising analyzing a performance characteristic of the servers with the programs associated with the servers according to the first mapping and the determining determines an expected performance characteristic for the second mapping based on the analyzed performance characteristic of the first mapping.

26. The method of claim 25 wherein the analyzed performance characteristic and the expected performance characteristic are related to server load.

27. The method of claim 25 wherein the analyzed performance characteristic and the expected performance characteristic are server load variance.

28. The method of claim 27 wherein the analyzing analyzes a performance characteristic of the servers associated with each of a plurality of potential mappings and wherein the second mapping provides a minimum load variance of the plurality of potential mappings.

29. The method of claim 25 wherein the analyzing analyzes a performance characteristic of the servers associated with a plurality of potential mappings and wherein the determining determines the at least one expected performance characteristic only for potential mappings that meet a constraint.

30. The method of claim 29 wherein the constraint is at least one of a required association of a selected server and a selected program, and a maximum number of programs that can be associated with a selected server.

31. The method of claim 25 wherein the determining determines the expected performance characteristic using precalculated impacts of moves of programs between servers.

32. The method of claim 18 further comprising analyzing a performance characteristic of the servers associated with a plurality of mappings of the programs to the servers and to provide an indication of the second mapping, the second mapping being one of the plurality of mappings whose analyzed performance characteristic better meets a criterion than another of the plurality of mappings.

33. The method of claim 18 wherein the second mapping meets at least one predetermined criterion.

34. The method of claim 33 wherein the at least one predetermined criterion is at least one of (1) that a load for a selected server is less than a threshold load, (2) that a selected program is associated with a selected server, and (3) that a selected server has less than a threshold number of programs associated with the selected server.

35. A computer program product for use in a system configured to be used with a data communication network that includes a plurality of servers and a plurality of programs to be run by the servers to provide a plurality of services to devices communicating with the servers over the network, the computer program product residing on a computer-readable medium and comprising computer-readable and computer-executable instructions for causing a computer to determine a suggested mapping of the programs to the servers that is different than a current mapping of the programs to the servers.

36. The computer program product of claim 35 wherein the instructions are configured to cause the computer to determine the suggested mapping such that the suggested mapping would have yielded better server resource utilization over a past time period than the current mapping.

37. The computer program product of claim 36 wherein the instructions are configured to cause the computer to determine the suggested mapping such that the suggested mapping would have yielded better load balancing over the past time period than the current mapping.

38. The computer program product of claim 36 wherein the instructions are configured to cause the computer to determine the suggested mapping such that the suggested mapping would have yielded better cumulative server resource utilization for the servers over the past time period than the current mapping.

39. The computer program product of claim 36 wherein the instructions are configured to cause the computer to analyze a performance characteristic of the servers to determine the suggested mapping.

40. The computer program product of claim 39 wherein the instructions are configured to cause the computer to measure the performance characteristic.

41. The computer program product of claim 40 wherein the instructions are configured to cause the computer to measure the performance characteristic of the servers over time with the programs associated with the servers according to the current mapping and to determine the suggested mapping using values of the performance characteristic measured over time.

42. The computer program product of claim 35 wherein the instructions are configured to cause the computer to analyze a performance characteristic of the servers associated with the current mapping and to determine an expected performance characteristic of the suggested mapping based on the analyzed performance characteristic of the current mapping.

43. The computer program product of claim 42 wherein the analyzed performance characteristic and the expected performance characteristic are related to server load.

44. The computer program product of claim 42 wherein the analyzed performance characteristic and the expected performance characteristic are server load variance.

45. The computer program product of claim 44 wherein the instructions are configured to cause the computer to analyze a performance characteristic of the servers associated with a plurality of potential mappings and wherein the suggested mapping provides a minimum load variance of the plurality of potential mappings.

46. The computer program product of claim 42 wherein the instructions are configured to cause the computer to analyze a performance characteristic of the servers associated with a plurality of potential mappings and wherein the instructions are configured to cause the computer to determine the at least one expected performance characteristic only for potential mappings that meet a constraint.

47. The computer program product of claim 46 wherein the constraint is at least one of a required association of a selected server and a selected program, and a maximum number of programs that can be associated with a selected server.

48. The computer program product of claim 42 wherein the instructions are configured to cause the computer to determine the expected performance characteristic using precalculated impacts of moves of programs between servers.

49. The computer program product of claim 35 wherein the instructions are configured to cause the computer to analyze a performance characteristic of the servers associated with a plurality of mappings of the programs to the servers and to provide an indication of the suggested mapping, the suggested mapping being one of the plurality of mappings whose analyzed performance characteristic better meets a criterion than another of the plurality of mappings.

50. The computer program product of claim 35 wherein the instructions are configured such that the suggested mapping meets at least one predetermined criterion.

51. The computer program product of claim 50 wherein the at least one predetermined criterion is at least one of (1) that a load for a selected server is less than a threshold load, (2) that a selected program is associated with a selected server, and (3) that a selected server has less than a threshold number of programs associated with the selected server.
